(19) United States
(12) Patent Application Publication
(10) Pub. No.: US 2003/0189492 A1
(43) Pub. Date: Oct. 9, 2003

(54) Monitoring, alarm and automatic adjustment system for users of oxygen and compressed air

(76) Inventor: Mark R. Harvie, South Burlington, VT (US)

Correspondence Address: Law Offices Eric R. Benson, Esq., Champlain Station, Box 65238, Burlington, VT, 05406-5238, US

(21) Appl. No.: 10/404,464

(22) Filed: Apr. 1, 2003

Related U.S. Application Data
(60) Provisional application No. 60/369,791, filed on Apr. 4, 2002.

(51) Int. Cl. G08B 23/00

(52) U.S. Cl. 340/573.1; 340/611; 600/301; 340/679

(57) ABSTRACT

This invention relates to a monitoring, alarm and automatic adjustment system for oxygen and/or compressed air, specifically to warn users of oxygen and/or compressed air of low pressure and/or no supply and automatically adjust the flow of oxygen and/or compressed air to the optimum rate according to the actual real time monitored condition and physiological needs of the user.

### BACKGROUND ART

Pressure monitoring and alarm systems for users of oxygen and compressed air are known in the prior art. For example, U.S. Pat. No. 6,137,417 (McDermott, Oct. 24, 2000) discloses a removable pressure monitor and alarm that can be mounted on regulators used to regulate portable high-pressure gas cylinders. The device includes audio, visual, electronic and remotely transmitted alarms that are activated by a pressure switch monitoring the remaining supply in the gas cylinder through a conduit in the manifold. The audible alarm is a buzzer and the visual alarm is a light-emitting diode. The McDermott system is designed only for use with portable high pressure gas cylinders. Unlike the present invention disclosed herein, the McDermott system is not designed for portable liquid oxygen systems, oxygen concentrators and other oxygen delivery systems. The McDermott system also: does not provide a sensory warning; has a factory-set fixed alarm point; does not calculate how much time the user has left with a particular cylinder; and does not automatically adjust the amount of oxygen being delivered to the user, based on usage or the oxygen concentration in the user's blood.

U.S. Pat. No. 6,067,022 (Laswick et al., May 23, 2000) is a pressurized, gas-powered alarm that provides a visual/audio alarm when gas pressure falls below a selected minimum. The device can be installed in-line between a gas supply source and any gas-utilizing device. The preferred embodiment is an oxygen gas resuscitator/transport ventilator where oxygen is provided from pressurized cylinders or a pipeline through a transport ventilator to a patient's face mask. It can be used where volatile gases are present, unlike electric-powered alarms which can cause an explosion. The alarm device has a manifold with an input port to the gas supply, an output port to conduct the gas downstream, and a manifold chamber in between. An audible reed alarm and visual pneumatic alarm are connected to the manifold chamber via an alarm supply conduit, and are activated when pressurized gas passes to them. The alarm cannot be disabled except by removal. A supply gas pressure sensor and a pressure switch produce a flow of gas after sensing that the gas pressure has fallen below the minimum. Unlike the present invention disclosed herein, the Laswick invention: does not calculate how much time the user has left with a particular cylinder; does not automatically adjust the amount of oxygen being delivered to the user based on usage or the oxygen concentration in the user's blood; and the alarm must be removed in order to be disabled.

U.S. Pat. No. 4,990,894 (Loescher et al., Feb. 5, 1991) is a ventilator monitor and alarm apparatus with multiple alarms. The device uses two mechanical pressure switches for low pressure. This allows the operator to select a low-pressure threshold that is optimum for monitoring the patient without affecting a second pressure threshold which activates an alarm if the patient's breathing cycle pressure does not pass through the threshold within a pre-selected amount of time. A preferred embodiment has flashing LED displays of the low and high threshold pressure settings, and a positive pressure breath indicator on an LCD bar graph manometer display. The device has an automatic “ON”, an alarm silence button and a flashing low-battery LED indicator.

U.S. Pat. No. 4,598,279 (Nowacki et al, Jul. 1, 1986) is a pressure monitor for either anesthesiology gas or oxygen supplied to a patient. The monitor is connected to a patient ventilating circuit by a simple T connector. The monitor includes a pair of crank arms. A bellows device bears against and raises or lowers metal spring members, depending on whether gas pressure is high or low. The spring members engage one crank arm when gas pressure is too low, and engage another when gas pressure is too high. An audible alarm and red light (either LED or incandescent) are activated if the spring member closes against either crank arm. The pressure alarm includes a pneumatic switch and an adjustable time delay so it can be activated immediately or after a delay of up to 60 seconds. A preset pneumatic-electrical switch connected to an oxygen supply line indicates low oxygen pressure.

U.S. Pat. No. 4,536,756 (DePasquale et al., Aug. 20, 1985) is a device used with oxygen or other gas cylinders that sounds an alarm or flashes a light when gas supply is running low. A metallic pin is inserted through the lens of the gas gauge dial but does not come in contact with the gauge face. The indicator arm on the dial moves as pressure decreases and makes contact with the pin at the point where gas level is too low. This contact completes an electrical circuit, causing an audible piezo alarm to activate and/or a light to flash. The circuit has two lead wires, each connected to a battery. One of the leads is connected to a metal part of the regulator and another to the pin in the gauge. Means of grounding the device to the regulator-valve portion of the cylinder include a magnet, chain, clip or alligator clips.

U.S. Pat. No. 4,187,842 (Schreiber, Feb. 12, 1980) is a pressure monitor to warn if the patient is disconnected from the ventilator. Three switches are connected to the breathing system and each switch is preset to alarm with an audio and LED alarm when pressure exceeds a predetermined threshold.

A number of pressure monitoring and warning systems are designed for use by scuba divers. U.S. Pat. No. 6,201,478 B1 (Hollis, Mar. 13, 2001) teaches a method and device for a scuba dive computer with a low air pressure warning device. A signal generator has an infrared electronic switch or switches mounted internally in an analog gauge in a fixed position. When a switch is activated by a pre-selected low-pressure reading, a battery-powered sensor powers audible/visual alarms. An audible alarm also sounds for entry into a decompression zone, determined by a pressure depth transducer and read on a digital gauge. The preferred embodiment of the audible alarm is a piezo electric beeper 33. The visual alarm, which includes variable patterns and colors of flashing in increasing speed, is visible by backlighting the pressure gauge and computer dial face. The Hollis invention: is designed only for use by scuba divers using portable high-pressure gas cylinders; is not designed for portable liquid oxygen systems, oxygen concentrators and other oxygen delivery systems; does not provide a sensory warning; does not calculate how much time the user has left with a particular cylinder; and does not automatically adjust the amount of oxygen being delivered to the user based on usage or the oxygen concentration in the user's blood.

U.S. Pat. No. 6,054,929 (Garofalo, et al., Apr. 25, 2000) is a device that issues a warning signal to a diving instructor of low tank pressures in student tanks, so that the instructor can monitor a group of students. One embodiment of the device includes a pressure sensor, a circuit that converts the detected pressure into a pulse, and a circuit that transmits it to LEDs arranged on the control panel of a scuba diving computer. Another embodiment includes an analog or digital pressure gauge and an electrical circuit that transmits the datum so that it appears as a warning including LEDs arranged on the pressure gauge which then is illuminated. The purpose of the device is to have the warnings easily detectable by an instructor at a distance. The pressure sensor, transmitter, and computer are of known types. The Garofalo invention: does not provide sensory or audible warnings; does not calculate how much time the user has left with a particular cylinder; and does not automatically adjust the amount of oxygen being delivered to the user based on usage or the oxygen concentration in the user's blood.

U.S. Pat. No. 5,357,242 (Morgano, et al., Oct. 18, 1994) is a diver's air tank pressure gauge that detects air pressure in a compressed-air tank. It has: an acoustical and optical alarm system; an adjustable alarm pointer that can be set at the pressure at which the alarm is to be activated; and a crank assembly for changing the position of the alarm pointer. When air pressure in the tank reaches the alarm pressure limit set, an electric circuit closes and activates the alarm. The diver can turn off the alarm by resetting an alarm indicator.

U.S. Pat. No. 5,191,317 (Toth et al., Mar. 2, 1993) is a low-air warning system for scuba divers featuring a visible alarm. A pressure switch and an electromagnetic transmitter are positioned at/near the high-pressure air supply tank, and an electromagnetic receiver is positioned on the diver's mask. An air pressure sensor senses when airflow falls below a certain level, generating a visual alarm near the diver's mask featuring lights that change in color and frequency. A potential problem with this invention is that certain diving conditions may make it difficult for the diver to see the lights. The present invention disclosed herein uses vibration which does not require visual ability on the part of the diver.

U.S. Pat. No. 4,800,373 (Mayz, Jan. 24, 1989) is a low-pressure warning device for scuba divers that attaches to a fitting on the high-pressure stage of the air tank. The warning device has a battery-operated audible alarm contained in a housing attached adjacent to the pressure gauge near the head of the diver, and a visual alarm with colored lens. A two-stage warning first indicates low pressure and second, a dangerously low pressure. Unlike the present invention disclosed herein, it does not provide a vibratory warning.

U.S. Pat. No. 6,201,475 (Stumberg et al., Mar. 13, 2001) allows monitoring of a number of safety-related parameters, including pressure in his/her breathing system, ambient temperature and motion of the firefighter. A microprocessor is used to calculate how much time the firefighter has left, according to the amount of pressure left in the tank. A switch and transducer are connected to audible and blinking alarms, which are activated to alert the firefighter when remaining air time is low. The Stumberg invention is designed only for use with firefighters' pressurized air systems and does not provide a sensory warning. It calculates how much time the user has left with a particular cylinder according to the amount of pressure left in the tank, but does not automatically adjust the amount of oxygen being delivered to the user, based on usage.

As such, the basic concept of pressure monitoring and alarm systems and their use are disclosed.

While each of these prior art patents disclose pressure monitoring and alarm systems fulfill their respective particular objectives and requirements, and are most likely quite functional for their intended purposes, it will be noticed that none of the prior art cited disclose an apparatus and/or method that allow a user the comfort and security of a Monitoring, Alarm and Automatic Adjustment System providing a certain touch sensitive warning of low pressure and automatic pressure adjustments based upon real time actual needs based upon the user's blood oxygen concentration. As such, there apparently still exists the need for new and improved Monitoring, Alarm and Automatic Adjustment System for Oxygen and Compressed Air to maximize the benefits to the user and minimize the risks of injury from its use.

This invention differs from previous patented devices because: it uses vibration as an alarm; does not use a factory-set fixed alarm point to activate an alarm; and automatically adjusts the flow of oxygen/compressed air to the optimum rate required by each user in real time.

The prior art patents feature only visual and audible alarms. They do not disclose or teach vibratory alarm systems for oxygen or compressed air users. Users with visual impairments are not able to see a light-emitting diode (LED) alarm. An LED alarm is also not visible in direct sunlight. The user also may not be able to see an LED alarm because the regulator and tank are out of the user's line of sight (in the backseat of a car, at the user's side, resting on the ground) or because the user is not paying attention to it (reading, talking, watching television, dozing off, etc.). Users with hearing impairments are not able hear an audible buzzer alarm. Users also may not be able to hear a buzzer alarm because of competing noises such as music, television, conversation, etc.

The warning devices described in prior art patents are activated when pressure reaches a pre-determined set point, e.g. 500 p.s.i., that is set ahead of time at the factory. The problem with those systems is that they do not inform the user of how much time he or she has left to access another source of oxygen or compressed air. The rate of oxygen consumed by a user can change daily and hourly, depending on environmental factors such as the weather and the user's exertion level. The present invention disclosed herein does not utilize a pre-determined set point. Instead, a micro controller continuously monitors the amount of oxygen or compressed air being taken in by the user, and continuously updates the calculation of how much time the user has left to replace the cylinder before the current gas cylinder's contents are completely exhausted.

The prior art patents monitor only gas pressure. The present invention disclosed herein monitors not only gas pressure, but also the user's blood oxygen concentration level and pulse rate. The invention provides an automatic alarm when the user's blood oxygen concentration level is low, a digital display of the recommended new regulator setting, and mechanisms to automatically change the regulator setting to the new setting.

In these respects, the present invention disclosed herein substantially corrects the problems and limitations of the prior art and fulfills the need for such a device.

The vibration device of the present invention disclosed herein can be used with any system that delivers oxygen or compressed air to a user, including but not limited to: regulators for portable compressed oxygen cylinders, portable liquid oxygen containers, oxygen concentrators; and tanks used by scuba divers, firefighters, rescue personnel and flight crews. With oxygen delivery systems, the vibration device can be attached to the cannula at the point closest to where the user is taking in oxygen (nose or trachea). The vibration device can also be incorporated into a finger ring, a wrist or ankle bracelet, eyeglass clip, ear clip, necklace pendant and other items. For scuba diving, the vibration device can be attached near the mouthpiece. For firefighting, rescue and flight crews, it can be attached near the face mask.

### DISCLOSURE OF THE INVENTION

In view of the foregoing limitations inherent in the known types of oxygen and compressed air monitoring, delivery and warning systems now present in the prior art, the present invention provides an apparatus that has been designed to continuously monitor and adjust the flow of oxygen or compressed to a user based upon their real time needs derived from their pulse and blood oxygen concentration and provides the user with a reliable touch sensory vibration warning and time data for tank replacement needs which are improvements that are patently distinct over similar devices and methods which may already be patented or commercially available. As such, the general purpose of the present invention, which will be described subsequently in greater detail, is to provide a field designed apparatus and method of use that incorporates the present invention. There are many additional novel features directed to solving problems not addressed in the prior art.

The present invention disclosed herein is a vibration device and gauge system to warn users of oxygen or compressed air of situations when there gas supply is low pressure or empty and automatically adjusts the flow of oxygen or compressed air to the optimum rate based upon the user's actual needs being monitored continuously by the device. The electrically or battery-operated vibration device can be attached to any nasal cannula, mask, mouthpiece, tubing or other equipment through which compressed gases including oxygen or compressed air are administered to a user by mouth, nose or trachea. The device creates a sensory vibration that warns the user that their oxygen or compressed air supply has dropped below a preprogrammed level and/or has been cut off because of a crimp of the tubing or malfunction of the oxygen or compressed air supply system.

To attain this, the present invention generally comprises a vibration device operatively connected to a user and an activation device that receives an activation signal from a pressure, low battery, pulse and blood oxygen sensing and microprocessor device which is further connected to a display device that discloses in real time the tank pressure, the time remaining before the tank is exhausted, the user's pulse, the user's blood oxygen concentration, a manual mode setting and a low battery warning signal which is further operatively connected to a pressure regulating means that automatically changes the pressure of the compressed gases being delivered to a user based upon a real time calculation of the user's actual needs for the gas as determined from their blood oxygen concentration and pulse.

Several objects and advantages of the present invention are:

unlike the prior art monitoring and alarm systems the present invention provides an easily detectable and reliable multi variable vibration warning to a user. Also, unlike prior art this invention does provide a warning system that alerts a user of the time remaining until a tank of gas is exhausted, their pulse, when the battery power is low, and their blood oxygen level; and

the present invention also provides for the automatic adjustment of gas pressure to a user based upon their real time needs calculated by a microprocessor from the user's pulse and blood oxygen concentration.

These together with other objects of the invention, along with the various features of novelty which characterize the invention, will be pointed out with particularity in the claims filed herewith. For a better understanding of the invention, its operating advantages and the specific objects attained by its uses, reference should be had to the accompanying drawings and descriptive matter in which there is illustrated preferred embodiments of the invention.

In the present invention, a combination of pressure and temperature sensors are used with compressed gas cylinders to determine faults in the delivery of oxygen or compressed air to the user. The pressure and temperature sensors allow monitoring of the rate of flow of oxygen under different climate conditions. A pressure sensor can be used with an oxygen concentrator, compressed gas cylinder or liquid tank to alert the user that the oxygen supply tubing is kinked or blocked. With a compressed gas cylinder, the pressure and temperature sensor optimally would be located in the cannula near the point where it leaves the regulator, however, alternative mounting locations in the line between a tank and the user may be used. If there is a kink or blockage, a few p.s.i. of pressure will build up in the tubing, which can be detected by the sensor. With portable liquid oxygen, a commercially-available liquid float gauge can be used that reads the liquid level in the tank, or a solid state capacitive liquid tank probe or other probe can be developed for this purpose.

The pressure and temperature sensors are connected to a micro controller that reads the actual pressure level and temperature within the compressed cylinder and converts the signals received from the sensors to a displayable p.s.i. One component of the electronic control unit is a digital pressure gauge that utilizes a Micro Electro Mechanical Systems (MEMS) pressure sensor, a strain gauge diaphragm-type sensor or other type of electric signal pressure sensor.

The pressure gauge has outputs to allow audio and visual alarms. The user can press a button on the electronic control unit to select one or all of the vibration, audio and visual alarm modes. The LCD display shows which alarm modes have been selected for use.

The vibration alarm signal is generated by the micro controller. In the preferred embodiment of the invention, the vibration device is powered by an electric motor with an asymmetrical weight attached to the drive shaft. When power is supplied to the vibration motor, it causes the motor to vibrate. For oxygen users, the vibration motor can be housed in a lightweight plastic enclosure that can be attached or clipped to cannula tubing. When the alarm is activated, it causes a vibration that transfers through the tubing and to the user, providing a sensory alarm. The vibration motor can also be incorporated into rings, necklaces, bracelets, anklets, eyeglasses, eyeglass clips and other items.

In one mode, the micro controller has programmable set points for vibration, visual and auditory alarm conditions. The first alarm is preset to activate when the user has a certain amount of time left (e.g. 30 minutes) before using up the oxygen or compressed air in the cylinder, based on his or her usage with that cylinder. The second alarm is preset to activate when the user has a smaller amount of time left (e.g. 15 minutes). The frequency of the pulsation rate for the different alarms is adjustable. The vibration can be preprogrammed to be constant, or to become stronger or pulsate more quickly. The pulsation rate can be set at a lower frequency for the first alarm condition, and preset to increase in frequency when the second alarm is activated, in order to impress the user with the need to take action and find another source of oxygen or compressed air.

The user can push a touch-sensitive reset switch (akin to a snooze alarm on an alarm clock) in order to temporarily still the vibration for a set number of minutes. The reset switch can be deactivated when a minimum time and/or pressure condition exists, so that the alarm cannot be shut off without taking corrective action.

The present invention's electronic control unit interfaces to any pulse oximeter sensor to monitor the user's blood oxygen concentration level and pulse rate. With this information, the LCD display of the electronic control unit continuously or periodically displays the user's blood oxygen concentration level and pulse rate. When the blood oxygen concentration level goes below a predetermined level (generally determined by a medical professional attending the user), the electronic control unit automatically alerts the user of the low level through vibration, audio and/or visual alarms and displays the recommended regulator setting on the LCD. The alarm(s) continue until the electronic control unit senses that the regulator has been reset to the proper setting either manually by the user or automatically.

The regulator can be adjusted automatically either with a small motor or solenoid. The motor or solenoid is attached to the dial of the regulator. To increase the flow of oxygen, the electronic control unit provides a signal to the motor or a pulse to the solenoid to advance the regulator flow setting one increment at a time. To decrease the flow of oxygen (go back one setting) using a regulator dial that only turns in one direction, the dial turns one complete rotation first before decreasing the flow. To decrease the flow of oxygen using a regulator dial that turns in both directions, the dial will turn back.

### BRIEF DESCRIPTION OF THE DRAWINGS

FIG. 1 is a perspective view of the invention in use.

FIG. 2A is a perspective view of the ring mounted version of the vibration device.

FIG. 2B is a perspective view of the wrist or ankle bracelet mounted version of the vibration device.

FIG. 2C is a perspective view of the ultra lightweight version of the vibration device.

FIG. 2D is a perspective view of the dual version of the vibration device.

FIG. 2E is a perspective view of the triple version of the vibration device.

FIG. 2F is a perspective view of the eyeglass mounted version of the vibration device.

FIG. 2G is a perspective view of the single side mounted version of the vibration device.

FIG. 2H is a perspective view of the necklace or pendant version of the vibration device.

FIG. 3 is a cut-away perspective view of the vibration device.

FIG. 4 is a front view of the LCD display.

FIG. 5 is a cut-away side view of the electronic control unit.

### BEST MODES FOR CARRYING OUT THE INVENTION

I. Preferred Embodiments

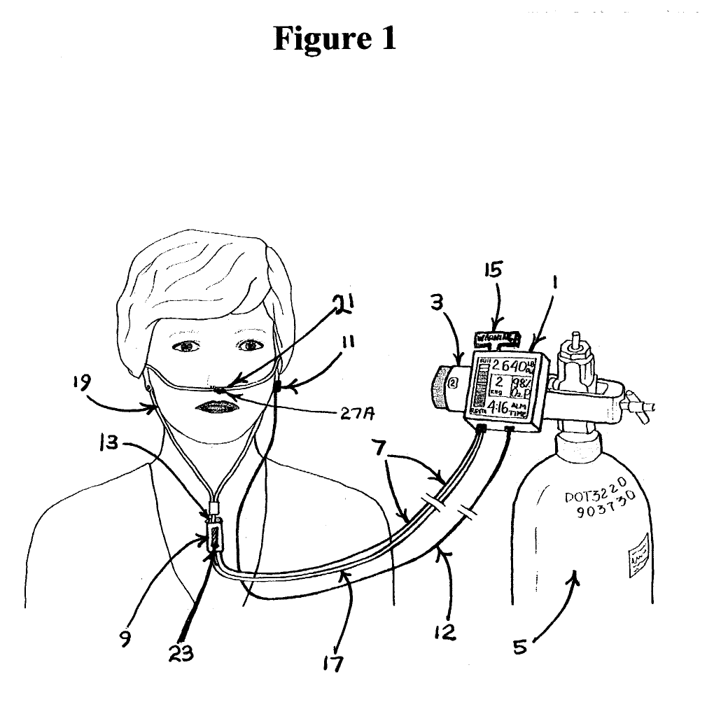

With reference now to the drawings, and in particular to FIGS. 1-5 thereof, a new and novel apparatus for a monitoring, alarm and automatic adjustment systems for users of oxygen and compressed air, embodying the principles and concepts of the present invention is disclosed.

List and General Description of Reference Numerals in the Description and Drawings

Any actual dimensions listed are those of the preferred embodiment. Actual dimensions or exact hardware details and means may vary in a final product or most preferred embodiment and should be considered means for so as not to narrow the claims of the patent.

(1) Electronic Control Unit

(3) Pressure Regulator

(5) Oxygen or Compressed Air Supply Cylinder or Tank

(7) Combined Enclosed Control Cable and Reset Switch Cable

(9) Vibration Device

(11) Pulse Oximeter Sensor

(12) Pulse Oximeter Cable

(13) Audible Alarm

(13A) Control Unit Mounted Audible Alarm

(15) Visual Alarm

(17) Oxygen or Compressed Air Supply Tubing

(19) Nasal Cannula Tubing

(21) Nasal Cannula

(23) Touch-sensitive Reset Switch

(25) Electronic Control Unit Housing

(27) Pressure and Temperature Sensor

(27A) Cannula Mounted Pressure and Temperature Sensor

(29) Micro Controller

(31) Analog Input Port

(32) Pressure or Liquid Oxygen Level Indicator

(33) LCD Display

(34) Recommended Regulator Setting Display

(35) Real Time Clock

(36) Current Pressure Display

(37) Pulse Oximeter Display

(38) Low Battery Indication

(39) Output Jack

(40) Battery

(41) Small Electric Motor

(43) Asymmetrical Weight

(45) Drive Shaft

(46) Hole

(47) Lightweight Case

(49) Mounting Slot

(51) Control Cable

(53) Reset Switch Cable

(54) Cable Hole

(57) Cover

(61) Ring

(63) Wrist or Ankle Bracelet

(65) Necklace or Pendant

(71) Eyeglasses

Detailed Description of the Preferred Embodiments:

FIGS. 1, 4 and 5 show a representation of each component of the oxygen monitoring, alarm and adjustment system constructed in accordance with the invention. The electronic control unit (1) is attached to the pressure regulator (3) which is attached to the oxygen or compressed air supply cylinder or tank (5). A combined enclosed control cable and reset switch cable (7) connects the electronic control unit (1) to the vibration device (9). The electronic control unit (1) performs multiple functions: it monitors the level of oxygen supply, monitors the rate of oxygen use, and interfaces by means of a pulse oximeter cable (12) with a pulse oximeter sensor (11) to monitor a patient's pulse or oxygen saturation. Using this information, the electronic control unit (1) calculates what the oxygen setting for the pressure regulator (3) should be and calculates alarm conditions such as low and/or no oxygen supply, low blood oxygen saturation level and low and/or high pulse rate. The electronic control unit (1) activates any of the following alarms: the vibration device (9), an audible alarm (13) or electronic control unit (1) mounted audible alarm (13A) or a visual alarm (15). The vibration device (9) is clipped to the oxygen or compressed air supply tubing (17) just below the junction of the nasal cannula tubing (19) and the oxygen or compressed air supply tubing (17). When the vibration device (9) is activated, vibration is felt by the user through the nasal cannula (21), providing a sensory alarm. A touch-sensitive reset switch (23) is located either on the exterior front surface of the vibration device (9). When pressed by the user, the touch sensitive reset switch (23) resets the audible alarm (13) or electronic control unit (1) mounted audible alarm (13A), the visual alarm (15) and the vibration device (9) much like a snooze button on an alarm clock. The touch sensitive reset switch (23) does not disable the audible alarm (13) or electronic control unit (1) mounted audible alarm (13A), the visual alarm (15) or the vibration device (9); instead it delays the reactivation of the audible alarm (13) or electronic control unit (1) mounted audible alarm (13A), the visual alarm (15) and the vibration device (9) for a pre-determined amount of time or sets a new alarm condition. The touch sensitive reset switch (23) is disabled once the alarm conditions reach a critical point. The audible alarm (13) or electronic control unit (1) mounted audible alarm (13A) and the visual alarm (15) may located in the electronic control unit housing (25), in the vibration device (9), on the pressure regulator (3), or any other location that would maximize the user's opportunity to observe and heed any warnings therefrom.

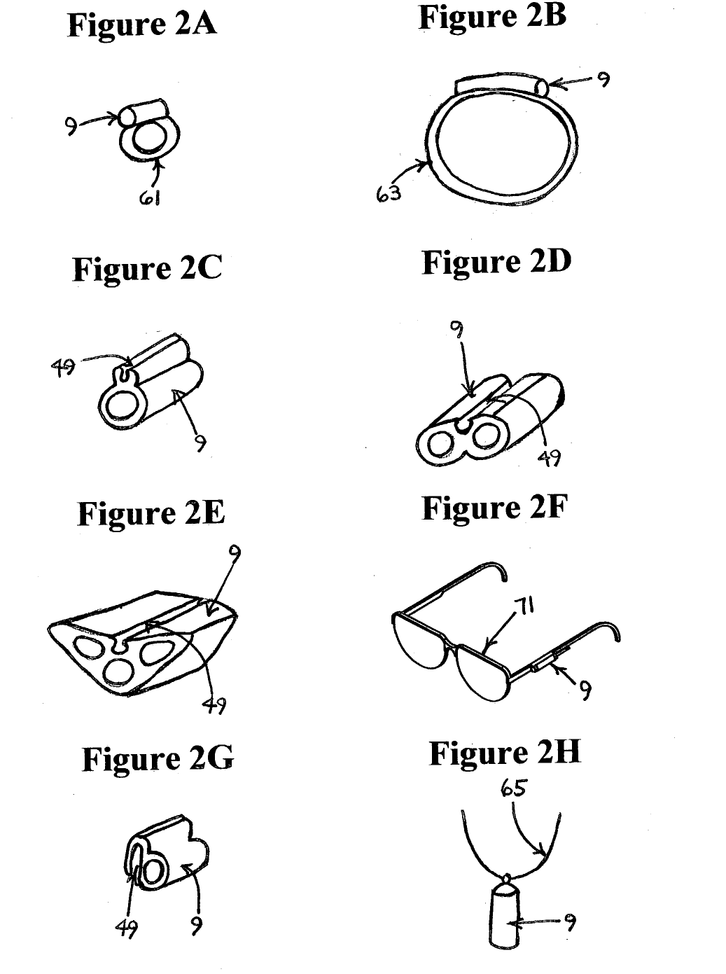

FIGS. 2A-2H are the perspective views of eight versions of the vibration device (9). The version in FIG. 2A depicts the vibration device (9) attached to a ring (61) to be worn by a user that may be remotely controlled by a transmitter or receiver means or wired directly to the electronic control unit (1). The version in FIG. 2B depicts the vibration device (9) attached to a wrist or ankle bracelet (63) to be worn by a user that may be remotely controlled by a transmitter or receiver means or wired directly to the electronic control unit (1). The version in FIG. 2C depicts the vibration device (9) in an ultra lightweight embodiment for user specified cannula placement using the mounting slot (49) that may be remotely controlled by a transmitter or receiver means or wired directly to the electronic control unit (1). The version in FIG. 2D depicts a dual embodiment utilizing two vibration devices (9) for user specified cannula placement using the mounting slot (49) that may be remotely controlled by a transmitter or receiver means or wired directly to the electronic control unit (1). Having two vibration devices (9) the version in FIG. 2D produces a stronger vibration for easier detection of the warning signal by the user. The version in FIG. 2E depicts a triple embodiment utilizing three vibration devices (9) for user specified cannula placement using the mounting slot (49) that may be remotely controlled by a transmitter or receiver means or wired directly to the electronic control unit (1). Having three vibration devices (9) The version in FIG. 2E produces an even stronger vibration for even easier detection of the warning signal by the user. Obviously multiple vibration devices (9) could be used, especially for severely handicapped individuals otherwise lacking in sensory perception. The version in FIG. 2F depicts the vibration device (9) attached to a pair of eyeglasses (71) to be worn by a user that may be remotely controlled by a transmitter or receiver means or wired directly to the electronic control unit (1). The version in FIG. 2G depicts the vibration device (9) in a side mounted embodiment to be clipped on to user selected objects, such as clothing, etc., using the mounting slot (49) and may be remotely controlled by a transmitter or receiver means or wired directly to the electronic control unit (1). The version in FIG. 2H depicts the vibration device (9) attached to a necklace or pendant (65) to be worn by a user that may be remotely controlled by a transmitter or receiver means or wired directly to the electronic control unit (1). Any of the versions depicted in FIGS. 2A-2H can be used in combination with one another or interchangeably according to the user's varied needs during the course of the day, e.g. while sleeping as versus awake, seated and reading with glasses on.

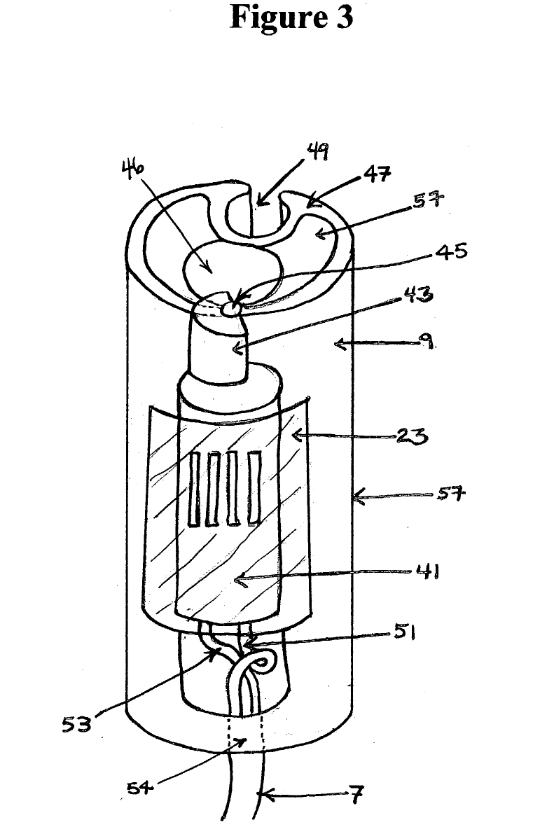

FIG. 3 is a cut-away perspective view of the vibration device (9). In this version of the invention, the vibration device (9) consists of a small electrical motor (41). An asymmetrical weight (43) is attached to the drive shaft (45) of the small electric motor (41). When the small electric motor (41) is running, the asymmetrical weight (43) causes the vibration device (9) to vibrate. The vibration device (9) is enclosed in a lightweight case (47) that has an integral cannula tube mounting slot (49). The vibration device (9) is clipped onto the oxygen supply tubing (17) using the cannula tube mounting slot (49). A hole (46) in the top of the lightweight case (47) enters into a cavity that runs down the interior of the lightweight case (47) and ends a fraction of an inch from the bottom of the lightweight case (47). The hole (46) is large enough to insert the small electric motor (41) for the vibration device (9).

The vibration device's (9) small electric motor (41) is controlled by the control cable (51). A cable hole (54) is drilled through the last fraction of an inch at the bottom of the lightweight case (47). This cable hole (54) is large enough for both the control cable (51) and touch-sensitive reset switch cable (53) to pass through. A knot is tied both the control cable (51) and the touch sensitive reset switch cable (53) for strain relief and to prevent the cables from passing through the cable hole (54) and are combined in the combined enclosed control cable and reset switch cable (7) between the vibration device (9) and the electronic control unit (1). A sealing adhesive is applied to the bottom of the lightweight case (47) near the cable hole (54). The small electric motor (41), the control cable (51) and touch-sensitive reset switch cable (53) are then inserted into the lightweight case (47). A cover (57) is installed over the hole (46) at the top of the case.

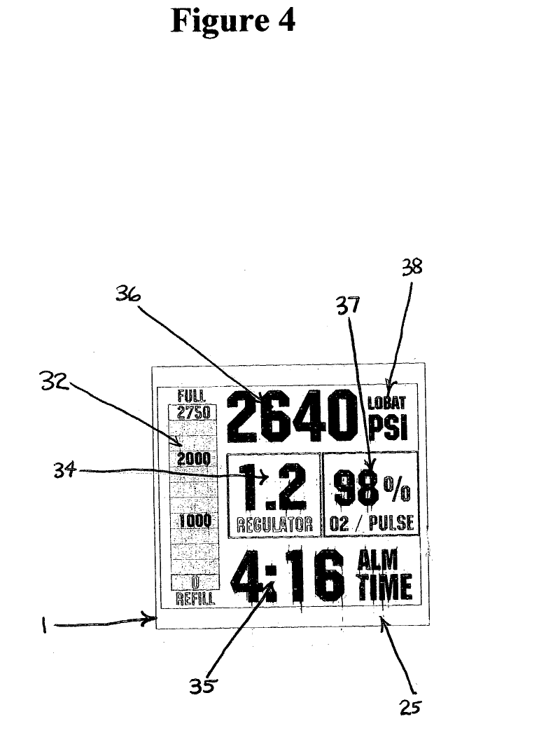

FIG. 4 is a perspective view of the LCD display (33) of the electronic control unit (1). The electronic control unit's (1) micro controller (29) interfaces with the cannula mounted pressure and temperature sensor (27A) or the pressure and temperature sensor (27), a real-time clock (35) and a pulse oximeter (11) depicted in FIG. 1 to calculate and display a number of status and alarm conditions. These alarm conditions can then be displayed in one or more of the following displays: a pressure or liquid oxygen level indicator (32) in the oxygen or compressed air supply cylinder or tank (5) depicted in FIG. 1, based on rate of use and current cannula mounted pressure and temperature sensor (27A) or the temperature and pressure sensor (27) reading; pulse oximeter display (37); current pressure display (36); and the recommended regulator setting display (34) for manual pressure adjustments of the pressure regulator (3) to the optimum flow rate. The real-time clock (35) has a digital interface to the micro controller (29). The cannula mounted pressure and temperature sensor (27A) or the pressure and temperature sensor (27) provides an analog signal to the micro controller's (29) analog input port (31). The micro controller (29) converts this signal to a digital representation that can be used to calculate the different alarm status conditions. The micro controller (29) outputs the status and alarm information to the liquid crystal display (LCD display (33)) (located on the face of the electronic control unit (1) or any other display method that can be used in a battery-operated device. The LCD display (33) provides: a digital and analog pressure or liquid oxygen level indicator (32) visually displaying the remaining levels of gas in the oxygen or compressed air supply cylinder or tank (5); by means of a real time clock (35) the time remaining in usage of the oxygen or compressed air supply cylinder or tank (5); low battery indication (38); an alarm condition; recommended regulator setting (34); by means of the pulse oximeter display (37) the pulse rate and blood oxygen level of the user.

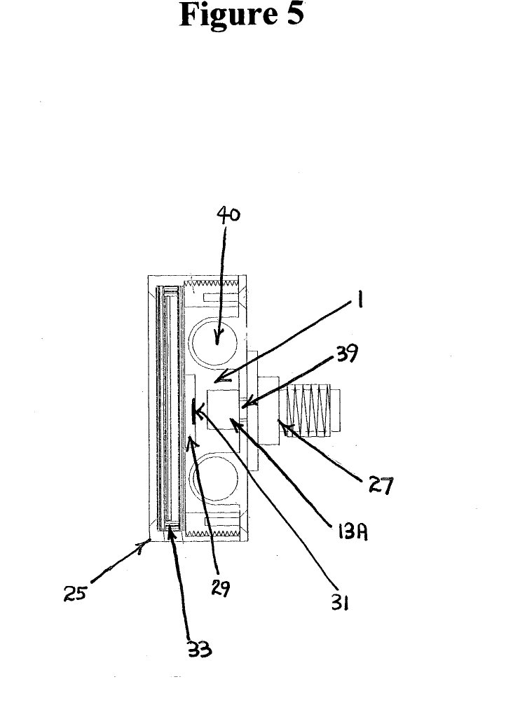

FIG. 5 is a cut-away side view of the electronic control unit (1). The electronic control unit (1) is battery (40) operated and ideally replaces the prior art pressure gauges for the compressed gas regulator (3). In the alternative, the electronic control unit (1) is used in conjunction with a prior art pressure gauge. The electronic control unit (1) may contain a pressure and temperature sensor (27) or be interfaced with the cannula mounted pressure and temperature sensor (27A) that is used to monitor the temperature of the passing gas and the pressure in the oxygen or compressed air supply cylinder or tank (5). The electronic control unit (1) has a micro controller (29) featuring multiple analog and digital input and output ports. One of the micro controller's (29) analog input ports (31) interfaces with the cannula mounted pressure and temperature sensor (27A) or the pressure and temperature sensor (27) to monitor the temperature of the passing gas and the gas pressure in the oxygen or compressed air supply cylinder or tank (5). Software in the micro controller (29) converts the signal received from the cannula mounted pressure and temperature sensor (27A) or the pressure and temperature sensor (27) into a pressure reading that is displayed on a liquid crystal display (LCD) (33) by means of the current pressure display (36). The pressure reading is used in conjunction with rate-of-use data and temperature to calculate the remaining gas supply time for the alarm output.

The electronic control unit (1) can contain an auditory beeper and lights for alarm conditions. The micro controller (29) controls the vibration device (9) and reads the status of the touch-sensitive reset switch (23). The connectors on the control cable (51) and reset switch cable (53) for the vibration device (9) and touch-sensitive reset switch (23) are plugged into the output jack (39).

In the preferred embodiment, the housing for the electronic control unit (1) is constructed from anodized aluminum, but can be constructed of other metals or plastics.

While my above descriptions of the invention, its parts, and operations contains many specificities, these should not be construed as limitations on the scope of the invention, but rather as exemplifications of present embodiments thereof. Many other variations are possible, for example, other embodiments, shapes, and sizes of the device can be constructed to fit on a user and work with a unit designed to work by the principles of the present invention; various materials, shapes, sizes, colors and configurations can be employed in the unit's design that would provide interesting embodiment differences to users including such practical designs as would, for instance conceal the unit.

Accordingly, the scope of the invention should be determined not by the embodiments illustrated, but by the claims and their legal equivalents as filed herewith.

Having described my invention, I claim:

1. A monitoring, alarm and automatic adjustment system for users of oxygen and compressed air comprised of:
a compressed gas storage means;
a pressure regulator means attached to the compressed gas storage means such that the pressure regulator means can regulate the discharge of a gas from the gas storage means;
an electronic control unit attached to the pressure regulator means such that the electronic control unit can activate the pressure regulator means and thereby control the discharge of the gas from the gas storage means;
a user specified length of nasal cannula tubing attached to the pressure regulator means such that the discharge of the gas from the gas storage means can pass through the pressure regulator means into the nasal cannula tubing;
a nasal cannula attached to the nasal cannula tubing such that the gas within the nasal cannula tubing can pass into the nasal cannula and then discharge into the nasal area of the user;
a pressure and temperature sensor attached to the nasal cannula such that the pressure and temperature of the gas as it passes through the nasal cannula may be measured by the pressure and temperature sensor;
a pulse detection means functionally attached to the user;
a blood oxygen concentration detection means functionally attached to the user;
the pressure and temperature sensor, the pulse detection means and the blood oxygen concentration detection means are each functionally connected to the electronic control unit and the electronic control unit is also functionally connected to an electronic control unit pressure and temperature sensor such that the electronic control unit will interpret data it receives by the functional connection from the pressure and temperature sensor, the pulse detection means, the blood oxygen concentration detection means and the electronic control unit pressure and temperature sensor and will automatically adjust the pressure regulator means such that a user selected gas pressure at the nasal cannula will be maintained; and
at least one alarm means functionally attached to the electronic control unit such that if the user selected gas pressure at the nasal cannula is not maintained the electronic control unit will activate the alarm means.

2. The monitoring, alarm and automatic adjustment system for users of oxygen and compressed air of claim 1 wherein the alarm means is at least one vibrator.

3. The monitoring, alarm and automatic adjustment system for users of oxygen and compressed air of claim 1 wherein the alarm means is at least one audible signal producing device.

4. The monitoring, alarm and automatic adjustment system for users of oxygen and compressed air of claim 1 wherein the alarm means is at least one visual signal producing device.

5. The monitoring, alarm and automatic adjustment system for users of oxygen and compressed air of claim 1 wherein the alarm means is comprised of:
at least one vibrator;
at least one audible signal producing device; and
at least one visual signal producing device.

6. The monitoring, alarm and automatic adjustment system for users of oxygen and compressed air of claim 1 wherein the alarm means is attached to a ring.

7. The monitoring, alarm and automatic adjustment system for users of oxygen and compressed air of claim 1 wherein the alarm means is attached to a bracelet.

8. The monitoring, alarm and automatic adjustment system for users of oxygen and compressed air of claim 1 wherein the alarm means is attached to eyeglasses.

9. The monitoring, alarm and automatic adjustment system for users of oxygen and compressed air of claim 1 wherein the alarm means is attached to a necklace.

10. The monitoring, alarm and automatic adjustment system for users of oxygen and compressed air of claim 1 wherein the alarm means is attached to the nasal cannula tubing.

11. The monitoring, alarm and automatic adjustment system for users of oxygen and compressed air of claim 1 wherein the alarm means is attached to the electronic control unit.

12. The monitoring, alarm and automatic adjustment system for users of oxygen and compressed air of claim 1 wherein the pressure and temperature sensor, the pulse detection means, the blood oxygen concentration detection means and the electronic control unit pressure and temperature sensor each are comprised of:
a transmitter wherein the transmitter transmits a signal to a receiver that is functionally attached to the electronic control unit.

13. The monitoring, alarm and automatic adjustment system for users of oxygen and compressed air of claim 1 wherein the alarm means is comprised of:
an alarm receiver wherein the alarm receiver receives a signal from an electronic control unit transmitter.

14. The monitoring, alarm and automatic adjustment system for users of oxygen and compressed air of claim 1 wherein the alarm means are attached to a ring, a bracelet, an anklet, a pair of eyeglasses, a necklace and the electronic control unit.

15. The monitoring, alarm and automatic adjustment system for users of oxygen and compressed air of claim 1 wherein the alarm means is removably attached to the user by Velcro.

16. The monitoring, alarm and automatic adjustment system for users of oxygen and compressed air of claim 1 wherein the alarm means is removably attached to the user by being clipped in a user specified location.
